(19) United States
(12) Patent Application Publication
(10) Pub. No.: US 2021/0221286 A1
(43) Pub. Date: Jul. 22, 2021

(54) VEHICLE SOUND GENERATION DEVICE

(71) Applicant: Mazda Motor Corporation, Hiroshima (JP)

(72) Inventors: Yasuhiko MIURA, Aki-gun (JP); Keisuke AGUSA, Aki-gun (JP)

(73) Assignee: Mazda Motor Corporation, Hiroshima (JP)

(21) Appl. No.: 17/120,308

(22) Filed: Dec. 14, 2020

(30) Foreign Application Priority Data
Jan. 21, 2020 (JP) 2020-007342

(51) Int. Cl. B60Q 5/00; H04R 1/02; H04R 3/00; G10K 15/02

(52) U.S. Cl. CPC B60Q 5/005; H04R 1/025; H04R 2499/13; G10K 15/02; H04R 3/00

(57) ABSTRACT

A vehicle sound generation device includes a sound control circuit that sets a plurality of frequencies according to a number of motor revolutions and sound pressures to be applied to the plurality of frequencies and generates a sound signal representing a synthetic sound including the sounds of the plurality of frequencies to which the set sound pressures have been applied, a speaker that outputs a sound according to the sound signal, generated by the sound control unit 12, and a travel situation estimation circuit that estimates a travel situation in which the driver accelerates or decelerates a vehicle at a rate below a predetermined threshold. The sound control circuit generates the sound signal representing only the single sound of the frequency in a range from 400 Hz to 900 Hz among the sounds of the plurality of frequencies when the travel situation is estimated.

### CROSS-REFERENCE TO RELATED APPLICATIONS

This application claims priority to JP 2020-007342, filed in Japan on Jan. 21, 2020, the contents of which is hereby incorporated by reference.

### TECHNICAL FIELD

The present disclosure relates to a vehicle sound generation device and, more particularly, to a vehicle sound generation device that outputs a predetermined sound during a travel of a vehicle.

### BACKGROUND

A vehicle sound generation device that outputs, to the driver, a sound of a predetermined frequency according to the number of revolutions of the power source of a vehicle has been conventionally developed. For example, a technique for generating a sound of a higher frequency as the number of motor revolutions is larger in an electric vehicle (such as an electric motorcycle) driven by an electric motor. In this technique, the rate of changes in the frequency to changes in the number of motor revolutions is set larger in a low speed range than in a high speed range of the number of motor revolutions. Accordingly, the behavior (vehicle speed) of the vehicle is transmitted to the driver by changes in the frequency of the sound provided for the driver.

### SUMMARY

The present disclosure describes a vehicle sound generation device mounted in a vehicle that travels with a rotary power source including an electric motor and/or an engine, the vehicle sound generation device including a sound control circuit configured to set a plurality of frequencies according to a number of revolutions of the rotary power source and sound pressures to be applied to the plurality of frequencies, and generate a sound signal representing a synthetic sound including sounds of the plurality of frequencies to which the set sound pressures have been applied; a speaker configured to output a sound according to the sound signal generated by the sound control circuit; and a travel situation estimation circuit configured to estimate a travel situation in which a driver accelerates or decelerates the vehicle at a rate below a predetermined threshold, wherein the sound control circuit generates the sound signal representing only a single sound of a frequency in a range from 400 Hz to 900 Hz among the sounds of the plurality of frequencies when the travel situation estimation circuit estimates the travel situation.

### BRIEF DESCRIPTION OF THE DRAWINGS

FIG. 1 is an explanatory diagram illustrating a vehicle sound generation device according to an embodiment of the present disclosure.

FIG. 2 is a structural diagram illustrating the vehicle sound generation device according to the embodiment of the present disclosure.

FIG. 3 is a frequency map according to the embodiment of the present disclosure.

FIG. 4A is graph of a sound pressure map according to the embodiment of the present disclosure.

FIG. 4B is a table of a sound pressure map according to the embodiment of the present invention.

FIG. 5 is an explanatory diagram illustrating equal loudness curves.

FIG. 6 is a flowchart illustrating sound generation processing according to the embodiment of the present disclosure.

FIG. 7 is an explanatory diagram illustrating the operation and effect of the vehicle sound generation device according to the embodiment of the present disclosure.

### DETAILED DESCRIPTION OF THE DRAWINGS

In a situation in which the vehicle accelerates or decelerates gently, for example, in the situation in which the vehicle travels on a winding road, the driver performs a minute accelerator operation. In this situation, a vehicle sound generation device in accordance with the present application outputs a sound so that the driver can perform an appropriate accelerator operation in such a travel situation. Specifically, the driver grasps the operational state of a vehicle and the state of the power source based on the sound output from the vehicle sound generation device, so that the driver can perform a correct accelerator operation suitable for the travel situation of the vehicle.

A vehicle sound generation device according to an embodiment of the present disclosure will be described with reference to the accompanying drawings.

### <Structure of Vehicle Sound Generation Device>

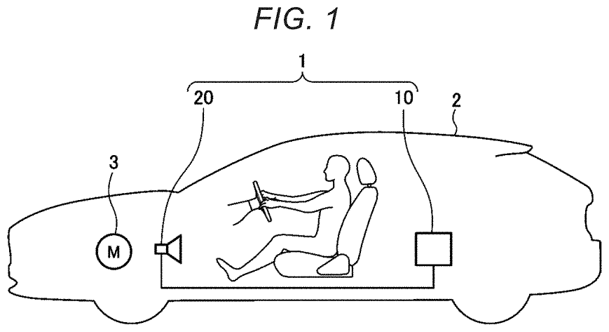

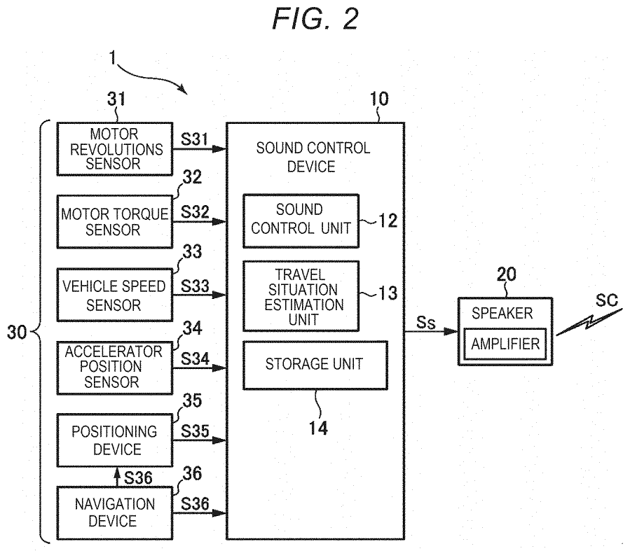

First, the structure of the vehicle sound generation device according to the embodiment of the present disclosure will be described with reference to FIGS. 1 and 2. FIG. 1 is an explanatory diagram illustrating the vehicle sound generation device according to the embodiment of the present disclosure and FIG. 2 is a structural diagram illustrating the vehicle sound generation device according to the embodiment of the present disclosure.

As illustrated in FIGS. 1 and 2, a vehicle sound generation device 1 according to the embodiment includes a sound control device 10 that is mounted in a vehicle 2, a speaker 20 that outputs a predetermined sound to a driver in a vehicle interior, and a sensor group 30 of various sensors that detect various types of information.

The vehicle 2 is an electric vehicle (EV) having an electric motor 3 as a rotary power source. Since the vehicle 2 does not have an internal combustion engine (such as a gasoline engine or a diesel engine), so-called engine noise is not generated during a travel. The electric motor 3 generates operating noise, but the operating noise of a motor is smaller than the noise of an engine. Therefore, the driver in the vehicle can hardly recognize the operating noise of the motor. In the embodiment, the vehicle sound generation device 1 generates the sound according to the operation situation of the electric motor 3 so that the driver can grasp the operation situation of the power train of the vehicle 2 including the electric motor 3.

The sound control device 10 includes a circuit and is a controller that includes one or more processors as central processing units (CPU) that execute programs, a memory (storage unit 14) that includes, for example, a RAM (random access memory) and a ROM (read only memory) and stores various programs and databases, a data input/output device for inputting and outputting electric signals, and the like. Moreover, the functionality of the sound control device 10, to be discussed below, may be implemented using circuitry or processing circuitry which includes general purpose processors, special purpose processors, integrated circuits, ASICs (“Application Specific Integrated Circuits”), conventional circuitry, controllers, and/or combinations thereof which are configured or programmed to perform the disclosed functionality. Processors and controllers are considered processing circuitry or circuitry as they include transistors and other circuitry therein. In this disclosure, any circuitry, units, controllers, or means are hardware carry out or are programmed to perform the recited functionality. The hardware may be any hardware disclosed herein or otherwise known which is programmed or configured to carry out the recited functionality. When the hardware is a processor or controller which may be considered a type of circuitry, the circuitry, means, or units are a combination of hardware and processing instructions that configure the hardware and/or processor. In the following, the sound control device 10 may also be referred to as sound control circuit 10, sound control circuitry 10 and/or processing circuitry.

The databases in the storage unit 14 store a frequency map and a sound pressure map described later, and the like. The sound control device 10 is communicably connected to other in-vehicle devices via an in-vehicle communication line. The sound control device 10 outputs a sound signal Ss including sound information (such as the frequency and the sound pressure) to the speaker 20 by causing the processors to execute programs based on various types of information from the sensor group 30. In some implementations, the processors/circuitry of the sound control device 10 function as the sound control unit 12 and the travel situation estimation unit 13 as described later. In other implementations, the sound control unit 12 and/or the travel situation estimation unit 13 comprise separate processors/circuitry form that of the sound control device 10.

The speaker 20 is a sound output unit having an amplifier. The speaker 20 receives the sound signal Ss from the sound control device 10, amplifies the sound signal Ss with a predetermined amplification factor, and outputs a sound (typically, a synthetic sound) SC based on the sound signal Ss. It should be noted here that the speaker 20 does not need to be provided in the vehicle interior as long as the driver can recognize the sound SC generated by the speaker 20.

The sensor group 30 includes a motor revolutions sensor 31 that detects the number of motor revolutions of the electric motor 3, a motor torque sensor 32 that detects the motor torque of the electric motor 3, a vehicle speed sensor 33 that detects the vehicle speed of the vehicle 2, and an accelerator position sensor 34 that detects the accelerator opening corresponding to the operation amount of the accelerator pedal of the vehicle 2. These sensors 31, 32, 33, and 34 transmit signals S31, S32, S33, and S34 corresponding to the detected information to the sound control device 10 through the in-vehicle communication line. The motor torque does not need to be detected by the motor torque sensor 32 and the motor torque (corresponding to the requested motor torque) may be calculated based on the accelerator opening or the like by an ECU in the vehicle 2 in another example.

Furthermore, the sensor group 30 includes a positioning device 35 and a navigation device 36. The positioning device 35 includes a GPS receiver, a gyro sensor, and the like, obtains the position (current position) of the vehicle 2, and transmits a signal S35 corresponding to this position of the vehicle 2 to the sound control device 10 through the in-vehicle communication line. The navigation device 36 internally stores map information and transmits a signal S36 corresponding to this map information to the sound control device 10 through the in-vehicle communication line. In addition, the navigation device 36 also transmits the signal S36 corresponding to the map information to the positioning device 35. The map information includes road information and the like, and this road information includes the road type (such as a high-speed road, a general road, or a winding road), interchange (IC) information, and junction (JCT) information, the altitude of a road, the curvature of a road, and the like.

For example, the positioning device 35 calculates the x-, y-, and z-coordinates of the vehicle 2 using at least one of the global navigation satellite system (GNSS), dead-reckoning navigation, and road-to-vehicle communication using Wi-Fi and the like. In addition, the positioning device 35 may calculate the position on the map of the vehicle 2 by map matching based on the map information obtained from the navigation device 36. The map information stored in the navigation device 36 does not need to be used and may use the map information stored in the sound control device 10 in another example. In still another example, the map information stored in a predetermined server device may be obtained from this server device.

In the embodiment, the sound control unit 12 of the sound control device 10 sets a plurality of frequencies according to the number of revolutions of the motor and the sound pressures to be applied to the plurality of frequencies and generates the sound signal Ss representing a synthetic sound including sounds of the plurality of frequencies to which the set sound pressures have been applied. In addition, the travel situation estimation unit 13 of the sound control device 10 estimates the travel situation (referred to below as the first travel situation) in which the driver accelerates or decelerates the vehicle 2 gently based on at least one of the position of the vehicle 2 obtained by the positioning device 35, the map information (particularly, the road information) obtained by the navigation device 36, and the accelerator opening detected by the accelerator position sensor 34. When the travel situation estimation unit 13 does not estimate the first travel situation, the travel situation of the vehicle 2 is the travel situation in which the vehicle 2 travels at a substantially constant speed or the travel situation in which the vehicle 2 accelerates or decelerates more quickly than in the first travel situation and, in the following description, such travel situations are collectively referred to as the “second travel situation”.

In particular, in the embodiment, when the travel situation estimation unit 13 estimates the first travel situation, the sound control unit 12 generates the sound signal Ss representing only the sound (single sound) of a single frequency in the range from 400 Hz to 900 Hz among the sounds of the plurality of frequencies without generating the sound signal Ss representing the synthetic sound including the sounds of the plurality of frequencies as described above. That is, the vehicle sound generation device 1 outputs the synthetic sound including the sounds of the plurality of frequencies from the speaker 20 in the second travel situation and outputs the single sound of the frequency in the range from 400 Hz to 900 Hz from the speaker 20 in the first travel situation.

Here, the first travel situation will be specifically described. The first travel situation is the travel situation in which the vehicle 2 accelerates or decelerates gently. In particular, the first travel situation corresponds to the travel situation in which the driver needs to perform a correct accelerator operation so as to minimize the jolt (jerk) caused in the vehicle 2 when the vehicle 2 travels on a road in which the curvature and the altitude thereof change. For example, the first travel situation includes the situation in which the vehicle 2 travels on a winding road or the situation in which the vehicle speed needs to be kept constant on a road with many ups and downs. In the first travel situation described above, an accelerator operation of, for example, approximately 20% to 50% is performed. That is, the change amount of the accelerator opening per a predetermined time is approximately 20% to 50%. In this case, the driver performs an accelerator operation of approximately 20% to 50% in less than one second to obtain a small torque in a short time and performs an accelerator operation of approximately 20% to 50% in one second or more to change the torque gently in several seconds to several tens of seconds. In contrast to the first travel situation described above, in the second travel situation, for example, the change amount of the accelerator opening per a predetermined time is less than 20% or equal to or more than 50%.

### <Sound Generation Processing>

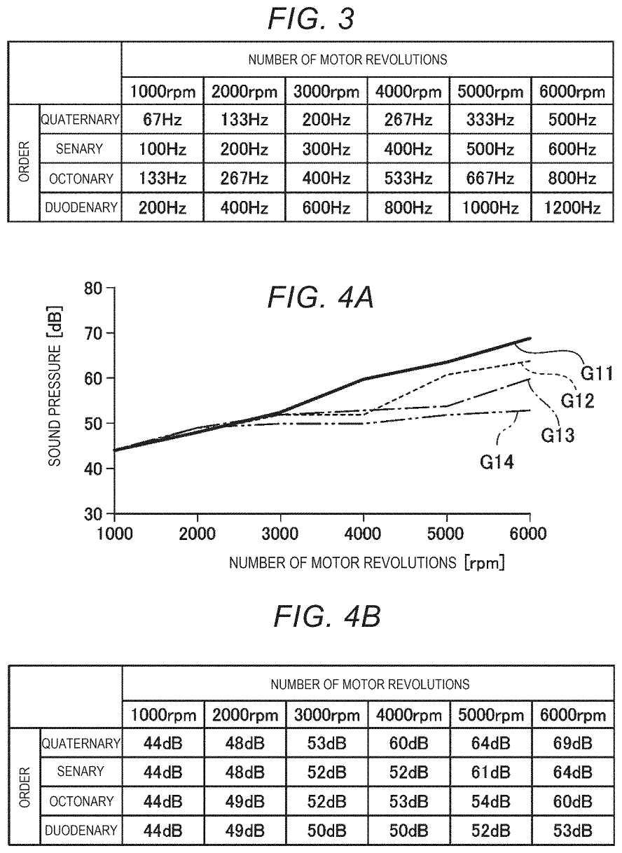

Next, the sound generation processing by the vehicle sound generation device 1 according to the embodiment of the present disclosure will be described with reference to FIGS. 3 and 4A-4B. FIG. 3 illustrates the frequency map according to the embodiment of the present disclosure and FIGS. 4A and 4B illustrate the sound pressure map according to the embodiment of the present disclosure.

In the sound generation processing, first, the sound control unit 12 of the sound control device 10 sets a plurality of frequencies according to the number of motor revolutions with reference to the frequency map in the FIG. 3. The sound control unit 12 generates a plurality of sinusoidal waves of n-order frequencies using the number of motor revolutions as the primary frequency (reference frequency). In the embodiment, examples of setting four frequencies (quaternary, senary, octonary, and duodenary frequencies), that is, the quaternary frequency, the senary frequency, the octonary frequency, and the duodenary frequency are given (this means that a synthetic sound in which the sounds of the quaternary frequency, the senary frequency, the octonary frequency, and the duodenary frequency are synthesized is generated in the processing described later). It should be noted here that the four frequencies (quaternary, senary, octonary, and duodenary frequencies) do not need to be used, frequencies of different orders may be used, or less than four frequencies or five or more frequencies may be used (this is also true in the following examples).

In the frequency map in FIG. 3, the frequencies to be set according to the number of motor revolutions are defined for the quaternary, senary, octonary, and duodenary orders, respectively. In this frequency map, with respect to the same number of motor revolutions, the higher the order, the higher the frequency to be set. Also, with respect to the same order, the higher the numbers of motor revolutions, the higher the frequency to be set. The sound control unit 12 sets the quaternary, senary, octonary, and duodenary frequencies according to the current number of motor revolutions obtained by the motor revolutions sensor 31 with reference to such a frequency map. For example, when the current number of motor revolutions is 3000 rpm, the sound control unit 12 sets the quaternary frequency, the senary frequency, the octonary frequency, and the duodenary frequency to 200 Hz, 300 Hz, 400 Hz, and 600 Hz, respectively. Although only the frequencies corresponding to the six numbers of motor revolutions are illustrated for each order in FIG. 3, the frequency map actually defines the frequencies to be set for the more numbers of (innumerable) motor revolutions.

Next, in the sound generation processing, the sound control unit 12 of the sound control device 10 sets the sound pressures to be applied to the sounds of the quaternary frequency, the senary frequency, the octonary frequency, and the duodenary frequency. Specifically, the sound control unit 12 sets the sound pressures of the quaternary frequency, the senary frequency, the octonary frequency, and the duodenary frequency according to the number of motor revolutions as in the frequency with reference to the sound pressure map in FIGS. 4A and 4B.

FIG. 4A illustrates the sound pressure map represented by a graph and FIG. 4B illustrates the sound pressure map represented by a table. In FIG. 4A, lines G11, G12, G13, and G14 represent the sound pressures to be set for the sounds of the quaternary frequency, the senary frequency, the octonary frequency, and the duodenary frequency, respectively. As illustrated in FIGS. 4A and 4B, the sound pressure map defines the sound pressures to be set for the sounds of the quaternary frequency, the senary frequency, the octonary frequency, and the duodenary frequency according to the number of motor revolutions. Basically, for all the sounds of the quaternary frequency, the senary frequency, the octonary frequency, and the duodenary frequency, the higher the number of motor revolutions, the higher the sound pressure to be set. In addition, in the sound pressure map, the higher the number of motor revolutions, the larger the ratio of the sound pressures in the low frequency bands (quaternary and senary frequencies) to the total value (total sound pressure) of the quaternary frequency, the senary frequency, the octonary frequency, and the duodenary frequency. In another example, the sound pressure map illustrated in FIGS. 4A and 4B may be divided into different maps (four sound pressure maps) that define the sound pressures of the quaternary frequency, the senary frequency, the octonary frequency, and the duodenary frequency, respectively.

The sound control unit 12 sets the sound pressures according to the current number of motor revolutions to be applied to the quaternary frequency, the senary frequency, the octonary frequency, and the duodenary frequency with reference to the sound pressure map in FIGS. 4A and 4B. In the embodiment, when the travel situation estimation unit 13 does not estimate the first travel situation, that is, when the travel state of the vehicle 2 is the second travel situation, the sound control unit 12 generates the sound signal Ss representing the synthetic sound including the sounds of the quaternary frequency, the senary frequency, the octonary frequency, and the duodenary frequency for which the sound pressures have been set as described above.

In contrast, in the embodiment, when the travel situation estimation unit 13 estimates the first travel situation, the sound control unit 12 does not generate the sound signal Ss representing the synthetic sound described above and generates the sound signal Ss representing only the sound (single sound) of a single frequency in the range from 400 Hz to 900 Hz among the quaternary frequency, the senary frequency, the octonary frequency, and the duodenary frequency. In this case, the sound control unit 12 selects the order of the frequency to be applied as a single sound among the quaternary frequency, the senary frequency, the octonary frequency, and the duodenary frequency, that is, one of the quaternary order, senary order, octonary order, and duodenary order.

In one example, the sound control unit 12 selects a predefined fixed order of the frequency that probably belongs to the range from 400 Hz to 900 Hz. In this example, the sound control unit 12 typically selects the octonary order. In another example, the sound control unit 12 selects an order based on the current number of motor revolutions, in other words, the sound control unit 12 changes the order to be selected according to the current number of motor revolutions. That is, the sound control unit 12 selects the order of the frequency in the range from 400 Hz to 900 Hz in the current number of motor revolutions. In this example, when there are two or more orders of the frequencies that belong to the range from 400 Hz to 900 Hz (for example, as illustrated in FIG. 3, the frequencies of two orders (octonary and duodenary orders) belong to the range from 400 Hz to 900 Hz when the number of motor revolutions is 3000 rpm and the frequencies of three orders (senary, octonary, and duodenary orders) belong to the range from 400 Hz to 900 Hz when the number of motor revolutions is 4000 rpm), the highest order only needs to be selected from the two or more orders. In some implementations, the sound control unit 12 selects the highest order as described above in the situation in which it is difficult to accelerate or decelerate the vehicle 2 gently in the first travel situation, that is, in a situation in which it is difficult to perform a correct accelerator operation so as to minimize the jolt generated in the vehicle 2 during a travel (for example, in a situation in which the vehicle 2 travels on a road with a large curvature or a road with severe undulations).

In addition, in the embodiment, when generating a single sound in the first travel situation, the sound control unit 12 corrects the sound pressure (the sound pressure to be set according to the number of motor revolutions based on the map in FIGS. 4A and 4B) of this single sound in consideration of the characteristics of human hearing, specifically the characteristics according to equal loudness curves.

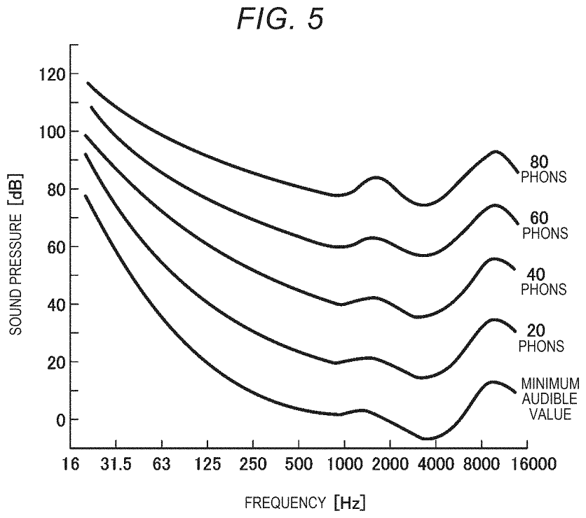

Here, equal loudness curves will be described with reference to FIG. 5. FIG. 5 illustrates the frequency (Hz) on the horizontal axis and the sound pressure (dB) on the vertical axis. Equal loudness curves represent the relationship between the frequency and the sound pressure at which the human ears feel the same magnitude of sound (represented by the unit “phon”), using contour lines. “Phon” is the unit representing the strength of a sound heard by human ears, that is, the auditory strength (loudness) of a sound. Equal loudness curves indicate that human hearing has the characteristics that the sensory loudness of a sound varies depending on the frequency even when the physical sound pressure is the same.

Taking such equal loudness curves into consideration, the sound control unit 12 corrects the sound pressure of a single sound to be set based on the map in FIGS. 4A and 4B so as to make the loudness heard by the driver identical between the case in which a single sound is applied and the case in which a synthetic sound is applied. Basically, since the number of sounds of a single sound is smaller than in a synthetic sound and the loudness heard by the driver tends to become smaller, the sound control unit 12 makes correction so as to increase the sound pressure of the single sound. However, the sound control unit 12 makes correction so as to reduce the sound pressure of a single sound when the frequency of the single sound is relatively high. This is because equal loudness curves represent that human hearing is sensitive to a sound of a relatively high frequency. That is, because of the characteristics, an increase in the sound pressure of a high frequency may cause harshness. In this case, the sound control unit 12 increases the amount (specifically, the amount of reduction of the sound pressure) of correction of the sound pressure of a single sound as the frequency is higher. Alternatively, since the frequency to be set becomes higher as the number of motor revolutions is higher according to the map in FIGS. 4A and 4B, the sound control unit 12 may increase the amount of correction of the sound pressure of a single sound as the number of motor revolutions is higher.

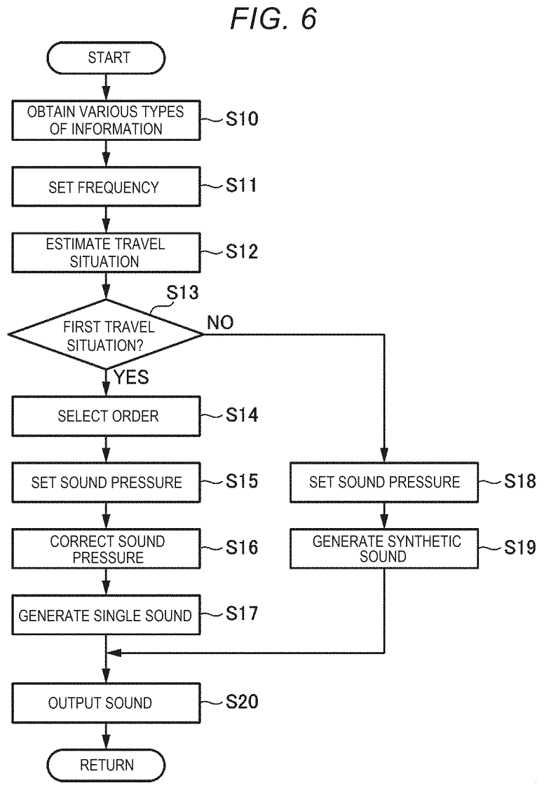

Next, the flow of sound generation processing according to the embodiment of the present disclosure will be described with reference to FIG. 6. FIG. 6 is a flowchart illustrating the sound generation processing according to the embodiment of the present disclosure. This sound generation processing is repeatedly executed by the vehicle sound generation device 1 (mainly the sound control device 10 and the speaker 20) in a predetermined cycle.

First, in steps 10, the sound control device 10 obtains various types of information from the sensor group 30. Specifically, the sound control device 10 obtains the number of motor revolutions detected by the motor revolutions sensor 31, the motor torque detected by the motor torque sensor 32, the vehicle speed detected by the vehicle speed sensor 33, the accelerator opening detected by the accelerator position sensor 34, the position of the vehicle 2 calculated by the positioning device 35, and the map information stored in the navigation device 36.

Next, in step S11, the sound control device 10 (specifically, the sound control unit 12) generates the sinusoidal waves of the quaternary, senary, octonary, and duodenary frequencies using the number of motor revolutions as the primary frequency (reference frequency). Specifically, the sound control unit 12 sets the frequency corresponding to the current number of motor revolutions obtained in step S10 for the sinusoidal waves of the quaternary, senary, octonary, and duodenary frequencies with reference to the frequency map stored in the storage unit 14 of the sound control device 10 (FIG. 3).

Next, in step S12, the sound control device 10 (specifically, the travel situation estimation unit 13) estimates the travel situation of the vehicle 2 based on at least one of the position of the vehicle 2 (the x-, y-, and z-coordinates and the position on the map), the map information (particularly, the road information), and the accelerator opening obtained in step S10. Specifically, the travel situation estimation unit 13 estimates the first travel situation by the methods described below. The methods described below may be combined as appropriate.

In one example, the travel situation estimation unit 13 estimates the travel situation of the vehicle 2 based on changes in the position of the vehicle 2. In this example, when the track of changes in the position of the vehicle 2 is far from a straight line, the travel situation estimation unit 13 determines that the vehicle 2 is traveling on a winding road, and estimates that the travel situation of the vehicle 2 is the first travel situation. In addition, the travel situation estimation unit 13 determines that the vehicle 2 is traveling on a road with many ups and downs when the height position (z-coordinate described above) of the vehicle 2 changes frequently, and estimates that the travel situation of the vehicle 2 is the first travel situation.

In another example, the travel situation estimation unit 13 estimates the travel situation of the vehicle 2 based on road information around the vehicle 2. In this example, the travel situation estimation unit 13 estimates that the travel situation of the vehicle 2 is the first travel situation when the road type included in the road information around the vehicle 2 represents a winding road. In addition, the travel situation estimation unit 13 determines that the vehicle 2 is traveling on a road that repeatedly moves up and down or left and right when the altitude or curvature of the road included in the road information around the vehicle 2 changes frequently, and estimates that the travel situation of the vehicle 2 is the first travel situation.

In still another example, the travel situation estimation unit 13 estimates the travel situation of the vehicle 2 based on changes in the accelerator opening. In this example, the travel situation estimation unit 13 estimates that the travel situation of the vehicle 2 is the first travel situation when the change amount of the accelerator opening per a predetermined time is approximately 20% to 50%. In particular, when the accelerator opening changes gradually at less than approximately 50%, the travel situation estimation unit 13 estimates that the travel situation of the vehicle 2 is the first travel situation.

In the above example, the accelerator opening is defined by percentage. This accelerator opening is defined by assuming that full close is 0% full open is 100%. In another example, the accelerator opening defined by an angle may be used. In still another example, the accelerator opening defined by a length may be used. In this case, the moving distance in the distal end portion of the accelerator pedal may be used.

Next, in step S13, the sound control device 10 (specifically, the sound control unit 12) determines whether the first travel situation has been estimated in step S12. As a result, when the first travel situation has been estimated (Yes in step S13), the sound control unit 12 proceeds to step S14.

Next, in step S14, the sound control unit 12 selects one order to be applied as a single sound among the quaternary order, the senary order, the octonary order, and the duodenary order for which the frequencies have been set in the step S11. In one example, the sound control unit 12 selects a predefined fixed order (for example, the octonary order). In another example, the sound control unit 12 selects the order that belongs to the range from 400 Hz to 900 Hz among the quaternary frequency, the senary frequency, the octonary frequency, and the duodenary frequency set in step S1. In this example, when there are two or more orders of frequencies that belong to the range of 400 Hz to 900 Hz, the sound control unit 12 only needs to select the highest order from the two or more orders. In particular, the sound control unit 12 selects the highest order as described above when the vehicle 2 is traveling on, for example, a road with a large curvature or a road with severe undulations.

Next, in step S15, the sound control unit 12 sets (that is, sets the sound pressure of a single sound) the sound pressure to be applied to the frequency of the order selected in step S14 with reference to the sound pressure map stored in the storage unit 14 of the sound control device 10 (FIGS. 4A and 4B). Specifically, the sound control unit 12 refers to the portion in the sound pressure map in which the relationship (corresponding to the selected order) between the number of motor revolutions and the sound pressure is defined and sets the sound pressure to be applied to the frequency of this order according to the current number of motor revolutions. It should be noted here that the sound control unit 12 sets all of the sound pressures to be applied to the frequencies (three frequencies) of the orders not selected in step S14 to zero.

Next, in step S16, the sound control unit 12 corrects the sound pressure set in step S15 in consideration of the characteristics of the equal loudness curves. Specifically, the sound control unit 12 corrects the sound pressure of a single sound according to the characteristics of the equal loudness curves so that the loudness of the sound heard by the driver is identical between the case in which the single sound is applied and the case in which a synthetic sound is applied. Basically, the sound control unit 12 makes correction so as to increase the sound pressure of the single sound because the number of sounds in a single sound is smaller than that in a synthetic sound and the loudness of the sound heard by the driver tends to become smaller. However, the sound control unit 12 makes correction so as to reduce the sound pressure of a single sound when the frequency of the single sound is relatively high. In this case, the sound control unit 12 increases the amount of correction of the sound pressure of a single sound (specifically, the amount of reduction of the sound pressure) as the frequency is higher or the number of motor revolutions is higher.

Next, in step S17, the sound control unit 12 generates the sound signal Ss representing a single sound to which the corrected sound pressure with respect to the frequency of the selected order has been applied, and outputs the sound signal Ss to the speaker 20. Next, in step S20, the speaker 20 receives the sound signal Ss and outputs the sound SC corresponding to the single sound.

In contrast, when the first travel situation is not estimated (No in step S13) in step S13, that is, when the travel state of the vehicle 2 is the second travel situation, the sound control unit 12 proceeds to step S18. In step S18, the sound control unit 12 sets the sound pressures to be applied to the quaternary frequency, the senary frequency, the octonary frequency, and the duodenary frequency set in step S11 according to the current number of motor revolutions with reference to the sound pressure map stored in the storage unit 14 of the sound control device 10 (FIGS. 4A and 4B).

Next, in step S19, the sound control unit 12 generates the sound signal Ss representing a synthetic sound including the quaternary frequency, the senary frequency, the octonary frequency, and the duodenary frequency for which the sound pressures have been set in step S18 and outputs the sound signal Ss to the speaker 20. Then, in step S20, the speaker 20 receives the sound signal Ss and outputs the sound SC corresponding to the synthetic sound.

The sound control unit 12 may set the sound pressure by further considering the motor torque obtained in step S10. Specifically, the sound control unit 12 may make correction so as to make the sound pressure higher as the motor torque is larger.

In addition, the travel situation estimation unit 13 may estimate the travel situation of the vehicle 2 by a method other than those illustrated above. For example, the travel situation estimation unit 13 may determine that the driver operates the vehicle 2 at low power consumption when the SOC (State of Charge) of the battery that supplies electric power for driving the electric motor 3 is less than a predetermined value or when the remaining travel distance (allowable travel distance) of the vehicle 2 according to the SOC of the battery is less than a predetermined value (for example, 50 km), and the travel situation of the vehicle 2 is the first travel situation. The remaining travel distance only needs to be calculated based on the SOC of the battery and the electricity consumption information of the vehicle 2.

### <Operation and Effect>

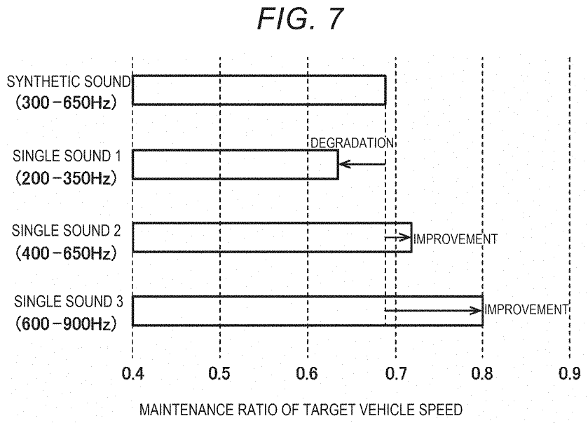

Next, the operation and effect of the vehicle sound generation device 1 according to the embodiment of the present disclosure will be described with reference to FIG. 7. FIG. 7 is an explanatory diagram illustrating the operation and effect of the vehicle sound generation device 1 according to the embodiment of the present disclosure. Specifically, FIG. 7 illustrates a simulation result when the test subject performed a task of traveling in a predetermined course with a target vehicle speed of 40 km/h kept while the test subject heard a sound output from the vehicle sound generation device 1. In this case, the vehicle sound generation device 1 outputs (1) a synthetic sound including the sounds of a plurality of frequencies (specifically, a synthetic sound including a frequency band similar to that of an actual engine sound), (2) a single sound 1 that is a sound of a single frequency from 200 Hz to 350 Hz, (3) a single sound 2 that is a sound of a single frequency from 400 Hz to 650 Hz, and (4) a single sound 3 that is a sound of a single frequency from 600 Hz to 900 Hz. Then, a maintenance ratio of the vehicle speed when the test subject travels in the predetermined course while these sounds are output from the vehicle sound generation device 1, more specifically, the ratio of the distance for which the target vehicle speed could be maintained to the total distance of a predetermined course.

It can be seen from FIG. 7 that, as a result of the synthetic sound, specifically, when the result in which the maintenance ratio of the vehicle speed was slightly lower than 0.7 was used as the reference value, the maintenance rate of the vehicle speed become worse than the reference value for single sound 1 of 200 Hz to 350 Hz, but the maintenance ratio of the vehicle speed become better than the reference value for single sound 2 of 400 Hz to 650 Hz and single sound 3 of 600 Hz to 900 Hz. In particular, the maintenance ratio of the vehicle speed is a large value of 0.8 for single sound 3 of 600 Hz to 900 Hz. These results indicate that the test subject did not easily feel changes in the sound according to changes in the speed for single sound 1, but the test subject easily felt changes in the sound according to changes in the speed in single sounds 2 and 3.

That is, since the test subject could perform appropriate accelerator operations for maintaining the constant vehicle speed by using the sound as a clue for single sounds 2 and 3 of 400 Hz to 900 Hz, the maintenance ratio of the vehicle speed become higher than the reference value. In other words, although the test subject tends to perform gentle acceleration or deceleration to maintain a constant vehicle speed, the test subject could appropriately control such acceleration or deceleration via delicate accelerator operations by using the single sounds 2 and 3 from the vehicle sound generation device 1 as a clue.

As described above, in the embodiment, the sound control unit 12 of the sound control device 10 controls the speaker 20 to output a synthetic sound including a plurality of frequencies according to the number of motor revolutions, but the sound control unit 12 controls the speaker 20 to output only the sound (single sound) of a single frequency in the range from 400 Hz to 900 among the sounds of the plurality of frequencies when the travel situation estimation unit 13 of the sound control device 10 estimates the first travel situation in which the driver accelerates or decelerates the vehicle 2 gently. In the first travel situation, it is possible for the driver to hear a single sound in the frequency band to which human ears are highly sensitive. As a result, the driver grasps the state (such as the number of revolutions) of the electric motor 3 and the operational state (such as the vehicle speed) of the vehicle 2 based on the sound output from the vehicle sound generation device 1, thereby enabling a correct accelerator operation suitable for the first travel situation.

In addition, in the embodiment, the sound control unit 12 of the sound control device 10 makes the sound pressure of the single sound lower as the frequency of a single sound is higher, so the harshness due to a high frequency sound can be suppressed.

In addition, in the embodiment, when two or more sounds in the range from 400 Hz to 900 Hz are present among the sounds of a plurality of frequencies, the sound control unit 12 of the sound control device 10 selects the sound of the highest frequency as a single sound among the two or more sounds. This enables the driver to hear a high frequency sound to which human hearing is highly sensitive. As a result, the driver can easily recognize a slight change in the state of the electric motor 3 and the operational state of the vehicle 2 through a change in the pitch of a sound from the vehicle sound generation device 1, thereby enabling a more correct accelerator operation.

In addition, in the embodiment, the travel situation estimation unit 13 of the sound control device 10 estimates the first travel situation based on changes in the position of the vehicle 2. Accordingly, the first travel situation can be accurately estimated by determining the geometry of the travel road based on changes in the position of the vehicle 2.

In addition, in the embodiment, the travel situation estimation unit 13 of the sound control device 10 estimates the first travel situation based on the road information around the vehicle 2. This can accurately estimate the first travel situation by determining the geometry of the travel road based on various types of information (such as, for example, the road type, and the altitude and curvature of the road) included in the road information.

In addition, in the embodiment, the travel situation estimation unit 13 of the sound control device 10 estimates the first travel situation based on changes in the accelerator opening. This can accurately estimate the first travel situation by determining the driver's intention of acceleration based on changes (such as progression) in the accelerator opening by the driver.

### <Modification>

Although a switch between a synthetic sound and a single sound is automatically made according to the travel situation estimated by the travel situation estimation unit 13 of the sound control device 10 in the above embodiment, a switch between a synthetic sound and a single sound may be made manually by a switch operation by the driver in another example. In still another example, a switch between a synthetic sound and a single sound may be made by a voice instruction by the driver.

Although the vehicle 2 is an electric vehicle (EV) and does not have an internal combustion engine in the embodiment described above, the vehicle 2 may have one or both of an internal combustion engine and an electric motor as the rotary power source in another example. In a modification in which the vehicle 2 has only an internal combustion engine, the driver can grasp the vehicle state and changes in the vehicle state more clearly via the sound generated by vehicle sound generation device 1 in addition to the operating sound of the engine. In addition, in this modification, the number of revolutions of the internal combustion engine (the number of engine revolutions) can be used to determine the frequency and the sound pressure of the sound SC. Furthermore, in another modification in which the vehicle 2 has both an internal combustion engine and an electric motor, the number of revolutions of one or both of the electric motor and the internal combustion engine can be used to determine the frequency and the sound pressure of the sound SC.

The present disclosure provides a vehicle sound generation device capable of outputting a sound that enables the driver to perform a correct accelerator operation in the travel situation in which a vehicle accelerates or decelerates gently.

In the present disclosure configured as described above, although the sound control circuit controls a speaker to output the synthetic sound including the plurality of frequencies according to the number of revolutions of the rotary power source, when the travel situation estimation circuit estimates the travel situation in which the driver accelerates or decelerates the vehicle gently, the sound control circuit controls the speaker to output only the sound of a single frequency in the range from 400 Hz to 900 Hz among the sounds of the plurality of frequencies. This enables the driver to hear a single sound in a high frequency band to which human ears are highly sensitive in the travel situation in which the vehicle accelerates or decelerates gently. As a result, the driver grasps the state (such as the number of revolutions) of the rotary power source and the operational state (such as the vehicle speed) of the vehicle based on a sound output from the vehicle sound generation device and can perform a correct accelerator operation suitable for the travel situation described above.

It is assumed that the travel situation described above in which the driver accelerates or decelerates the vehicle gently includes the situation in which the vehicle is actually accelerating or decelerating, the situation in which the vehicle accelerates or decelerates gently hereafter, and the situation in which the driver intends to accelerate or decelerate the vehicle gently. In one example, the travel situation described above corresponds to the situation in which the change amount of the accelerator opening per a predetermined time by the driver falls within a predetermined range.

In the present disclosure, the speaker makes a sound pressure of the single sound lower as the frequency of the single sound is higher.

According to the present disclosure configured as described above, the harshness due to a high frequency sound can be appropriately suppressed.

In the present disclosure, when two or more sounds of frequencies in the range from 400 Hz to 900 Hz are present among the sounds of the plurality of frequencies, the sound control circuit selects, as the single sound, the sound of the highest frequency from the two or more sounds.

According to the present disclosure configured as described above, it is possible for the driver to hear a high frequency sound to which human hearing is highly sensitive. As a result, the driver can easily recognize a slight change in the state of the rotary power source and the operational state of the vehicle through a change in the pitch of the sound from the vehicle sound generation device, thereby enabling a more correct accelerator operation.

In the present disclosure, the travel situation estimation circuit obtains a position of the vehicle and estimates the travel situation based on a change in the obtained position.

According to the present disclosure configured as described above, the geometry (such as, for example, a winding road or a road with many ups and downs) of this travel road is determined based on changes in the position of the vehicle and the travel situation can be accurately estimated.

In the present disclosure, the travel situation estimation circuit obtains road information around the vehicle and estimates the travel situation based on the obtained road information.

According to the present disclosure configured as described above, the travel situation can be accurately estimated by determining the geometry of the travel road based on various types of information (such as, for example, the road type, and the altitude and curvature of the road) included in the road information.

In the present disclosure, the travel situation estimation circuit obtains an accelerator opening corresponding to an operation amount of an accelerator pedal of the vehicle and estimates the travel situation based on a change in the obtained accelerator opening.

According to the present disclosure configured as described above, the travel situation can be accurately estimated by determining the driver's intention of acceleration based on the change in the accelerator opening by the driver.

### ADVANTAGE OF THE DISCLOSURE

The vehicle sound generation device according to the present disclosure outputs a sound that enables the driver to perform a correct accelerator operation in a travel situation in which a vehicle accelerates or decelerates gently.

### DESCRIPTION OF REFERENCE SIGNS AND NUMERALS

1: vehicle sound generation device
2: vehicle
3: electric motor
10: sound control device
12: sound control unit
13: travel situation estimation unit
14: storage unit
20: speaker (sound output unit)
30: sensor group
31: motor revolutions sensor
32: motor torque sensor
33: vehicle speed sensor
34: accelerator position sensor
35: positioning device
36: navigation device

1. A vehicle sound generation device mounted in a vehicle that travels with a rotary power source including an electric motor and/or an engine, the vehicle sound generation device comprising:
a sound control circuit configured to
set a plurality of frequencies according to a number of revolutions of the rotary power source and sound pressures to be applied to the plurality of frequencies, and
generate a sound signal representing a synthetic sound including sounds of the plurality of frequencies to which the set sound pressures have been applied;
a speaker configured to output a sound according to the sound signal generated by the sound control circuit; and
a travel situation estimation circuit configured to estimate a travel situation in which a driver accelerates or decelerates the vehicle at a rate below a predetermined threshold, wherein
the sound control circuit generates the sound signal representing only a single sound of a frequency in a range from 400 Hz to 900 Hz among the sounds of the plurality of frequencies when the travel situation estimation circuit estimates the travel situation.

2. The vehicle sound generation device according to claim 1,
wherein the speaker controls a sound pressure of the single sound to be lower as the frequency of the single sound is higher.

3. The vehicle sound generation device according to claim 2,
wherein, when two or more sounds of frequencies in the range from 400 Hz to 900 Hz are present among the sounds of the plurality of frequencies, the sound control circuit selects, as the single sound, the sound of a highest frequency from the two or more sounds.

4. The vehicle sound generation device according to claim 3,
wherein the travel situation estimation circuit obtains a position of the vehicle and estimates the travel situation based on a change in the obtained position.

5. The vehicle sound generation device according to claim 4,
wherein the travel situation estimation circuit obtains road information around the vehicle and estimates the travel situation based on the obtained road information.

6. The vehicle sound generation device according to claim 5,
wherein the travel situation estimation circuit obtains an accelerator opening corresponding to an operation amount of an accelerator pedal of the vehicle and estimates the travel situation based on a change in the obtained accelerator opening.

7. The vehicle sound generation device according to claim 1,
wherein, when two or more sounds of frequencies in the range from 400 Hz to 900 Hz are present among the sounds of the plurality of frequencies, the sound control circuit selects, as the single sound, the sound of a highest frequency from the two or more sounds.

8. The vehicle sound generation device according to claim 1,
wherein the travel situation estimation circuit obtains a position of the vehicle and estimates the travel situation based on a change in the obtained position.

9. The vehicle sound generation device according to claim 1,
wherein the travel situation estimation circuit obtains road information around the vehicle and estimates the travel situation based on the obtained road information.

10. The vehicle sound generation device according to claim 1,
wherein the travel situation estimation circuit obtains an accelerator opening corresponding to an operation amount of an accelerator pedal of the vehicle and estimates the travel situation based on a change in the obtained accelerator opening.

11. The vehicle sound generation device according to claim 2,
wherein the travel situation estimation circuit obtains a position of the vehicle and estimates the travel situation based on a change in the obtained position.

12. The vehicle sound generation device according to claim 2,
wherein the travel situation estimation circuit obtains road information around the vehicle and estimates the travel situation based on the obtained road information.

13. The vehicle sound generation device according to claim 2,
wherein the travel situation estimation circuit obtains an accelerator opening corresponding to an operation amount of an accelerator pedal of the vehicle and estimates the travel situation based on a change in the obtained accelerator opening.

14. The vehicle sound generation device according to claim 7,
wherein the travel situation estimation circuit obtains a position of the vehicle and estimates the travel situation based on a change in the obtained position.

15. The vehicle sound generation device according to claim 7,
wherein the travel situation estimation circuit obtains road information around the vehicle and estimates the travel situation based on the obtained road information.

16. The vehicle sound generation device according to claim 7,
wherein the travel situation estimation circuit obtains an accelerator opening corresponding to an operation amount of an accelerator pedal of the vehicle and estimates the travel situation based on a change in the obtained accelerator opening.

17. The vehicle sound generation device according to claim 8,
wherein the travel situation estimation circuit obtains road information around the vehicle and estimates the travel situation based on the obtained road information.

18. The vehicle sound generation device according to claim 8,
wherein the travel situation estimation circuit obtains an accelerator opening corresponding to an operation amount of an accelerator pedal of the vehicle and estimates the travel situation based on a change in the obtained accelerator opening.

19. The vehicle sound generation device according to claim 1,
wherein the speaker includes an amplifier, and
to output the sound, the speaker is configured to receive the sound signal from the sound control circuit, amplify the sound signal with a predetermined amplification factor, and then output the sound based on the amplified sound signal.

20. The vehicle sound generation device according to claim 1, further comprising:
a memory that stores sound pressure maps, wherein
the sound control circuit is configured to control an input and output of data, including the sound pressure maps, to the memory.
